(19) United States
(12) Patent Application Publication
(10) Pub. No.: US 2018/0068203 A1
(43) Pub. Date: Mar. 8, 2018

(54) SERVER, METHOD, NON-TRANSITORY COMPUTER READABLE MEDIUM ENCODED WITH PROGRAM, AND SYSTEM FOR RECOGNIZING INDIVIDUAL IDENTIFICATION INFORMATION OF MACHINE

(71) Applicant: FANUC CORPORATION, Minamitsuru-gun (JP)

(72) Inventor: Shinji NOGAMI, Yamanashi (JP)

(21) Appl. No.: 15/695,361

(22) Filed: Sep. 5, 2017

(30) Foreign Application Priority Data
Sep. 7, 2016 (JP) 2016-174526

(51) Int. Cl. G06K 9/62; H04L 29/08; G06K 9/46

(52) U.S. Cl. CPC G06K 9/6201; G06K 9/78; G06K 9/4609; H04L 67/125

(57) ABSTRACT

A server communicable with a plurality of machine tools via a network, includes a control unit and a storage unit, in which the control unit includes: an accumulating unit that collects display screen data from the machine tool at a predetermined time interval, and accumulates the display screen data in the storage unit along with time information and individual identification information of the machine tool; a receiver that receives a captured image of a display screen of a machine tool sent from an information terminal; a comparison unit that conducts a comparison between the captured image of the display screen of the machine tool received from the information terminal, and the display screen data accumulated in the storage unit, and specifies the display screen data that is matching; and a transmitter that transmits individual identification information of a specified machine tool as a result of the comparison to the terminal.

This application is based on and claims the benefit of priority from Japanese Patent Application No. 2016-174526, filed on 7 Sep. 2016, the content of which is incorporated herein by reference.

### BACKGROUND OF THE INVENTION

### Field of the Invention

The present invention relates to a server, method, non-transitory computer-readable medium encoded with a program, and system for recognizing individual identification information of machines.

### Related Art

In a factory, many conditions in which it is desired to acquire individual information using the individual identification information of a machine tool have been considered. For example, in order for abnormality to be found in the operation of a machine tool, a case has been considered of a person in charge of maintenance wanting to confirm the maintenance information of this machine tool (machine model number/maker, service part information of machine, etc.). Alternatively, a case has been considered of a person in charge of processing wanting to confirm the processing information of this machine tool (information of tool set in machine tool, workpiece information, machining schedule, machining results, processing program, data other than processing program, etc.) in order to understand the operating conditions of the machine tool. In such as case, since man-hours are required on each occasion upon confirming the machine documents, or confirming by making manipulations on the screen, it is necessary to be able to recognize the individual information of the machine easily. In this point, Patent Document 1 discloses as a method of obtaining individual identification information in a system consisting of a plurality of industrial machines and information terminals (portable type, tablet type, etc.), and an external server, a method of photographing the serial number, attached barcode, etc. of an industrial machine by way of an information terminal, and specifying the individual identification information of this industrial machine according to an identifier in the information terminal. In addition, Patent Document 2 discloses, as a system consisting of a plurality of manufacturing equipment and operator stations, a system in which the operator reads the photo ID (barcode, etc.) attached to manufacturing equipment by an image reader of the operating station (digital camera, etc.) so as to specify the manufacturing equipment according to the identification information (ID) thus acquired, and acquire the operation right of this manufacturing equipment.

Patent Document 1: Re-publication of PCT International Publication No. WO2013/094366

Patent Document 2: Japanese Unexamined Patent Application, Publication No. 2015-167016

### SUMMARY OF THE INVENTION

As described above, in order to obtain the individual information or identification information of the industrial machine or manufacturing equipment, an image identifier such as a barcode or QR code (registered trademark) is being used in both the system disclosed in Patent Document 1, and the system disclosed in Patent Document 2. However, allocating photo identifiers to the machines already installed in a factory requires time and labor.

Therefore, the present invention has an object of providing a server, method, program and system that can recognize individual identification information of machines, which can be easily realized in the case of machines already being installed in a factory, plant, etc.

A first server (e.g., the server 10 described later) according to a first aspect of the present invention is a server communicable with a plurality of machine tools (e.g., the machine tool 20 described later) via a network, including: a control unit (e.g., the control unit 101 described later) and a storage unit (e.g., the storage unit 102 described later), in which the control unit includes: an accumulating unit (e.g., the accumulating unit 111 described later) that collects display screen data from the machine tool at a predetermined time interval, and accumulates the display screen data in the storage unit along with time information and individual identification information of the machine tool; a receiver (e.g., the receiver 112 described later) that receives a captured image of a display screen of a machine tool sent from an information terminal (e.g., the information terminal 30 described later); a comparison unit (e.g., the comparison unit 113 described later) that conducts a comparison between the captured image of the display screen of the machine tool received from the information terminal, and the display screen data accumulated in the storage unit, and specifies the display screen data that is matching; and a transmitter (e.g., the transmitter 114 described later) that transmits individual identification information of a specified machine tool as a result of the comparison to the information terminal.

A second server (e.g., the server 15 described later) according to a second aspect of the present invention is a server communicable with a plurality of machine tools (e.g., the machine tool 25 described later) via a network, the server including a control unit (e.g., the control unit 151 described later) and a storage unit (e.g., the storage unit 102 described later), in which the control unit includes: a receiver (e.g., the receiver 112 described later) that receives a captured image of a display screen of a machine tool sent from an information terminal (e.g., the information terminal 30 described later); an instruction unit (e.g., the instruction unit 115 described later) that instructs sending of display screen data to the machine tool when receiving the captured image from the information terminal, and collects the display screen data along with time information and individual identification information of the machine tool; a comparison unit (e.g., the comparison unit 113 described later) that conducts a comparison between the captured image of the display screen of the machine tool received from the information terminal and the display screen data collected by the instruction unit, and specifies the display screen data that is matching; and a transmitter (e.g., the transmitter 114 described later) that transmits individual identification information of a specified machine tool as a result of the comparison to the information terminal.

A first method according to a third aspect of the present invention is a method executed by a server (e.g., the server 10 described later) communicable with a plurality of machine tools (e.g., the machine tool 20 described later) via a network, the method including the steps of: collecting display screen data from the machine tool at a predetermined time interval, and accumulating the display screen data in a storage unit (e.g., the storage unit 102 described later) along with time information and individual identification information of the machine tool; receiving a captured image of a display screen of a machine tool sent from an information terminal (e.g., the information terminal 30 described later); comparing between the captured image of the display screen of the machine tool received from the information terminal and the display screen data accumulated in the storage unit, and specifying the display screen data that is matching; and sending individual identification information of a specified machine tool as a result of the comparing to the information terminal.

A second method according to a fourth aspect of the present invention is a method executed by a server (e.g., the server 15 described later) communicable with a plurality of machine tools (e.g., the machine tool 25 described later) via a network, the method including the steps of: receiving a captured image of a display screen of a machine tool sent from an information terminal (e.g., the information terminal 30 described later); instructing sending of display screen data to the machine tool when receiving the captured image from the information terminal, and collecting the display screen data along with time information and individual identification information of the machine tool; comparing between the captured image of the display screen of the machine tool received from the information terminal and the display screen data collected in the step of instructing, and specifying the display screen data that is matching; and sending individual identification information of a specified machine tool as a result of the comparing to the information terminal.

A first program according to a fifth aspect of the present invention is a program for causing a computer to function as a server (e.g., the server 10 described later) communicable with a plurality of machine tools (e.g., the machine tool 20 described later) via a network, the program when executed by a computer causing the computer to perform processing of: collecting display screen data from the machine tool at a predetermined time interval, and accumulating the display screen data in a storage unit (e.g., the storage unit 102 described later) along with time information and individual identification information of the machine tool; receiving a captured image of a display screen of a machine tool sent from an information terminal (e.g., the information terminal 30 described later); comparing between the captured image of the display screen of the machine tool received from the information terminal and the display screen data accumulated in the storage unit, and specifying the display screen data that is matching; and sending individual identification information of a specified machine tool as a result of the comparing to the information terminal.

A second program according to a sixth aspect of the present invention is a program for causing a computer to function as a server (e.g., the server 15 described later) communicable with a plurality of machine tools (e.g., the machine tool 25 described later) via a network, the program when executed by a computer causing the computer to perform processing of: receiving a captured image of a display screen of a machine tool sent from an information terminal (e.g., the information terminal 30 described later); instructing sending of display screen data to the machine tool when receiving the captured image from the information terminal, and collecting the display screen data along with time information and individual identification information of the machine tool; comparing between the captured image of the display screen of the machine tool received from the information terminal and the display screen data collected in the processing of instructing, and specifying the display screen data that is matching; and sending individual identification information of a specified machine tool as a result of the comparing to the information terminal.

A first system according to a seventh aspect of the present invention is a system including a server (e.g., the server 10 described later) and a plurality of machine tools (e.g., the machine tool 20 described later), in which the server includes a control unit (e.g., the control unit 101 described later) and a storage unit (e.g., the storage unit 102 described later), in which the control unit has: an accumulating unit (e.g., the accumulating unit 111 described later) that collects display screen data from the machine tool at a predetermined time interval, and accumulates the display screen data in the storage unit along with time information and individual identification information of the machine tool; a receiver (e.g., the receiver 112 described later) that receives a captured image of a display screen of a machine tool sent from an information terminal; a comparison unit (e.g., the comparison unit 113 described later) that conducts a comparison between the captured image of the display screen of the machine tool received from the information terminal, and the display screen data accumulated in the storage unit, and specifies the display screen data that is matching; and a transmitter (e.g., the transmitter 114 described later) that transmits individual identification information of a specified machine tool as a result of the comparison to the information terminal, in which the machine tool has: an acquisition unit (e.g., the acquisition unit 211 described later) that acquires display screen data of the machine tool; and a transmitter (e.g., the transmitter 212 described later) that sends the display screen data acquired by the acquisition unit to the server.

A second system according to an eighth aspect of the present invention is a system including a server (e.g., the server 15 described later) and a plurality of machine tools (e.g., the machine tool 25 described later), in which the server includes a control unit (e.g., the control unit 151 described later) and a storage unit (e.g., the storage unit 102 described later), in which the control unit has: a receiver (e.g., the receiver 112 described later) that receives a captured image of a display screen of a machine tool sent from an information terminal; an instruction unit (e.g., the instruction unit 115 described later) that instructs sending of display screen data to the machine tool when receiving the captured image from the information terminal, and collects the display screen data along with time information and individual identification information of the machine tool; a comparison unit (e.g., the comparison unit 113 described later) that conducts a comparison between the captured image of the display screen of the machine tool received from the information terminal and the display screen data collected by the instruction unit, and specifies the display screen data that is matching; and a transmitter (e.g., the transmitter 114 described later) that transmits individual identification information of a specified machine tool as a result of the comparison to the information terminal, in which the machine tool has: an acquisition unit (e.g., the acquisition unit 211 described later) that acquires display screen data of the machine tool; a receiver (e.g., the receiver 213 described later) that receives an instruction of sending of the display screen data from the server; and a transmitter (e.g., the transmitter 212 described later) that sends the display screen data acquired by the acquisition unit to the server.

According to the present invention, it is possible to provide a server, method, program and system that can recognize individual identification information of machines, which can be easily realized in the case of machines already being installed in a factory, plant, etc.

### BRIEF DESCRIPTION OF THE DRAWINGS

FIG. 1 is a view showing the configuration of a system according to an embodiment of the present invention;

FIG. 2 is a view showing functional blocks of a server according to an embodiment of the present invention;

FIG. 3 is a view showing functional blocks of a machine tool according to an embodiment of the present invention;

FIG. 4 is a view showing functional blocks of an information terminal according to an embodiment of the present invention;

FIG. 5A is a view showing an operational flow of a system according to an embodiment of the present invention;

FIG. 5B is a view showing an operational flow of a system according to an embodiment of the present invention;

FIG. 6A is a view showing a specific example of an individual identification method used by the system according to an embodiment of the present invention;

FIG. 6B is a view showing a specific example of an individual identification method used by the system according to an embodiment of the present invention;

FIG. 6C is a view showing a specific example of an individual identification method used by the system according to an embodiment of the present invention;

FIG. 6D is a view showing a specific example of an individual identification method used by the system according to an embodiment of the present invention;

FIG. 6E is a view showing a specific example of an individual identification method used by the system according to an embodiment of the present invention;

FIG. 6F is a view showing a specific example of an individual identification method used by the system according to an embodiment of the present invention;

FIG. 7A is a view showing a display screen data example used by the system according to an embodiment of the present invention;

FIG. 7B is a view showing a display screen data example used by the system according to an embodiment of the present invention;

FIG. 7C is a view showing a display screen data example used by the system according to an embodiment of the present invention;

FIG. 7D is a view showing a display screen data example used by the system according to an embodiment of the present invention;

FIG. 8 is a view showing functional blocks of a server according to an embodiment of the present invention;

FIG. 9 is a view showing functional blocks of a machine tool according to an embodiment of the present invention;

FIG. 10A is a view showing an operational flow of a system according to an embodiment of the present invention;

FIG. 10B is a view showing an operational flow of a system according to an embodiment of the present invention;

FIG. 11A is a view showing a specific example of an individual identification method used by the system according to the embodiment of the present invention;

FIG. 11B is a view showing a specific example of an individual identification method used by the system according to the embodiment of the present invention;

FIG. 11C is a view showing a specific example of an individual identification method used by the system according to the embodiment of the present invention;

FIG. 11D is a view showing a specific example of an individual identification method used by the system according to the embodiment of the present invention;

FIG. 11E is a view showing a specific example of an individual identification method used by the system according to the embodiment of the present invention; and

FIG. 11F is a view showing a specific example of an individual identification method used by the system according to the embodiment of the present invention.

### DETAILED DESCRIPTION OF THE INVENTION

### 1. First Embodiment

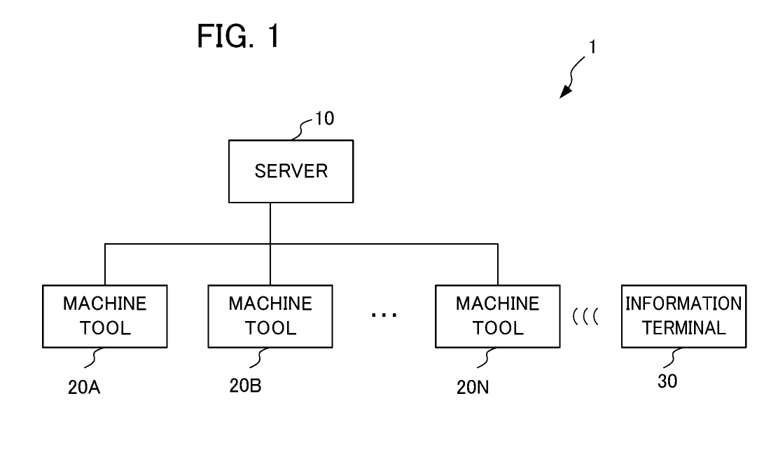

Hereinafter, a first embodiment of the present invention will be described in detail while referencing FIGS. 1 to 7D.

### <1.1 Configuration of Invention>

FIG. 1 is a view showing the configuration of a system according to the first embodiment of the present invention. A system 1 has a server 10, a plurality of machine tools 20A, 20B, . . . , 20N (these are abbreviated as “machine tool 20”), and an information terminal 30, and the server 10 and machine tools 20 are communicable view a network. In addition, the server 10 and information terminal 30 are also communicable by wire or wirelessly. Furthermore, clock units (not illustrated) of each of the server 10, machine tools 20 and information terminal 30 are synchronized.

### <1.2 Regarding Server>

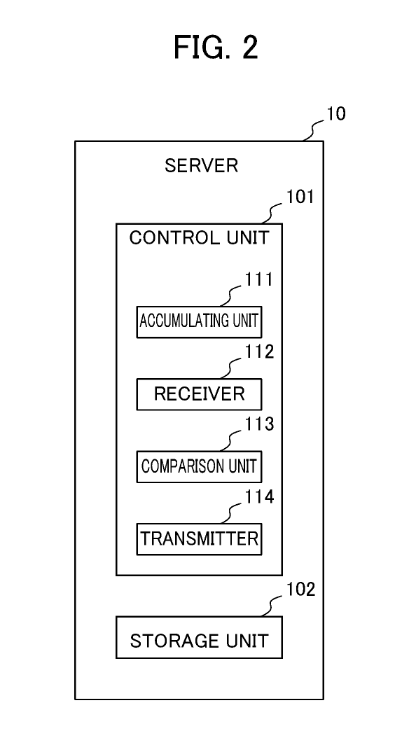

As shown in FIG. 2, the server 10 has a control unit 101 which executes processing of various data, etc., and a storage unit 102 that stores various data, etc.

The control unit 101 has a CPU, ROM, RAM, CMOS memory, etc., and these are well-known configurations to those skilled in the art, which are configured to be mutually communicable via a bus.

The CPU is a processor that controls the entirety of the server 10. By this CPU reading a system program and application programs stored in the ROM via the bus, and controlling the server 10 overall following this system program and application programs, the control unit 101 is configured so as to realize the functions of accumulating unit 111, receiver 112, comparison unit 113 and transmitter 114 as shown in FIG. 2, in order to compare between a captured image of the display screen of the machine tool 20 received from the information terminal 30 and display screen data collected from each machine tool 20 at a predetermined time interval, and specify the matching display screen data and individual identification information of the machine tool. Various data such as temporary calculation data and display data are stored in the RAM. The CMOS memory is configured as non-volatile memory that is backed up by a battery (not illustrated), whereby the storage state is maintained even if the power source of the server 10 is turned OFF.

The accumulating unit 111 collects display screen data of the machine tools 20 from each machine tool 20, and accumulates in the storage unit 102 along with time information. This display screen data is for comparing with captured images which capture the display screen of the machine tool 20 by the information terminal 30, and are sent to the server 10, in order for the user to obtain the individual identification information of the machine tool 20. The accumulating unit 111 collects the display screen data in 1-second intervals, for example.

The receiver 112 receives, from the information terminal 30, captured images of the display screen of the machine tool 20 captured by the information terminal 30, in order for the user to obtain the individual identification information of the machine tool 20, as described above.

The comparison unit 113 compares the captured image of the display screen of the machine tool 20 received from the information terminal 30 by the above-mentioned receiver 112, and the display screen data collected from each machine tool 20 by the above-mentioned accumulating unit 111, having time information of the same time as, or within a fixed range of, the time information of the captured image, and specifies the machine tool corresponding to the captured image. This comparison is capable of being conducted by detecting/extracting feature portions (corner, border line, rectangular region, etc.) of the captured images and respective display screen data, and matching the feature value.

The transmitter 114 sends, to the information terminal 30, the individual identification information of the machine tool 20 for which being the photographing target of the captured image was specified, after comparison by the comparison unit 113 between the captured image of the display screen of the machine tool 20 received from the information terminal 30 and the display screen data collected from each machine tool 20, having time information of the same time or within a fixed time of the time information of this captured image.

The storage unit 102 stores the display screen data collected from the machine tools 20 by the accumulating unit 111 along with the time information. In addition, the storage unit 102 stores individual information of each machine tool 20 in advance, as well as storing based on information uploaded from the machine tool. Individual information, for example, is the model number, maker, installation location, installation date, service parts information of the machine tool, information of a tool set in the machine tool, information of a workpiece set in the machine tool, machining schedule information, machining results information, IP address, numerical control information, amplifier information, motor information, sensor information, machining program information, etc. used in the machine tool.

### <1.3 Regarding Machine Tool>

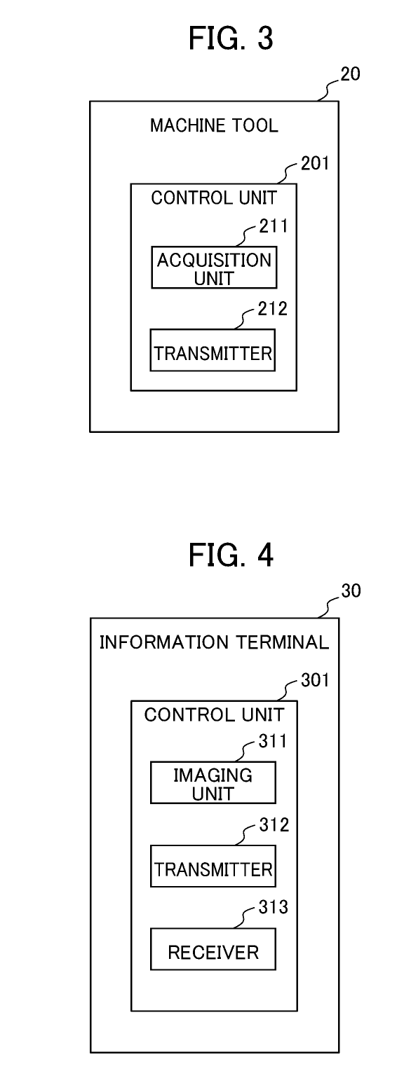

The machine tool 20 has a control unit 201 as shown in FIG. 3.

The control unit 201 has a CPU, ROM, RAM, CMOS memory, etc., and these are well-known configurations to those skilled in the art, which are configured to be mutually communicable via a bus.

The CPU is a processor that controls the entirety of the machine tool 20. By this CPU reading out a system program and application programs stored in the ROM via a bus, and controlling the entirety of the machine tool 20 following this system program and application programs, the control unit 201 is configured so as to realize the functions of the acquisition unit 211 and transmitter 212 as shown in FIG. 3, in order to acquire the display screen data of this machine tool 20, and send to the server 10. Various data such as temporary calculation data and display data are stored in the RAM. The CMOS memory is configured as non-volatile memory that is backed up by a battery (not illustrated), and for which the storage state is retained even if the power source of the machine tool 20 is turned OFF.

The acquisition unit 211 acquires display screen data of each machine tool 20 for use in the comparison with the above-mentioned captured image, from a display screen control unit (not illustrated) of this machine tool 20.

The transmitter 212 transmits the display screen data of each machine tool 20 acquired by the above-mentioned acquisition unit 211 to the server 10.

### <1.4 Regarding Information Terminal>

The information terminal 30 has a control unit 301 as shown in FIG. 4.

The control unit 301 has a CPU, ROM, RAM, CMOS memory, etc., and these are well-known configurations to those skilled in the art, which are configured to be mutually communicable via a bus.

The CPU is a processor that controls the entirety of the information terminal 30. By this CPU reading out a system program and application programs stored in the ROM via a bus, and controlling the entirety of the information terminal 30 following this system program and application programs, the control unit 301 is configured so as to realize the functions of the imaging unit 311, transmitter 312 and receiver 313 as shown in FIG. 4, in order to capture a display screen of the machine tool 20, send the captured image to the server 10, and receive individual identification information of the captured machine tool 20 from the server 10. Various data such as temporary calculation data and display data are stored in the RAM. The CMOS memory is configured as non-volatile memory that is backed up by a battery (not illustrated), whereby the storage state is maintained even if the power source of the machine tool 20 is turned OFF.

The imaging unit 311 captures the display screen of the machine tool 20 for which the user desires specification of the individual identification information.

The transmitter 312 sends, to the server 10, a captured image which was captured by the imaging unit 311 to be used in the comparison with the display screen data of each machine tool 20 in the server 10.

The receiver 313 receives individual identification information for the machine tool 20, specified according to the comparison by the server 10, between the captured image sent to the server 10 by the above-mentioned transmitter 312, and the respective display screen data collected in the server 10 from each machine tool 20.

### <1.5 Regarding Operation>

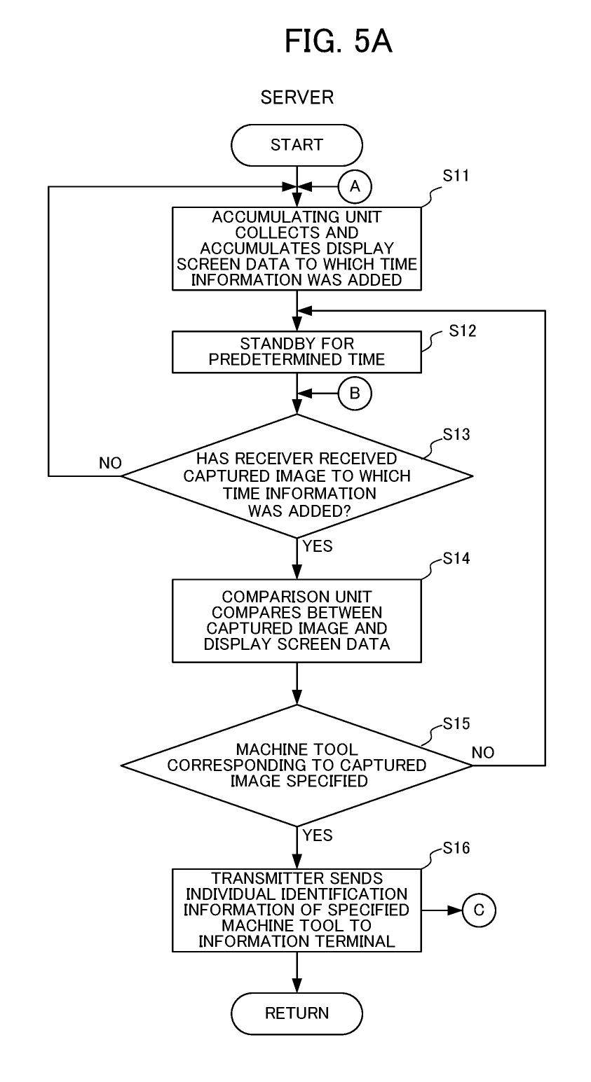

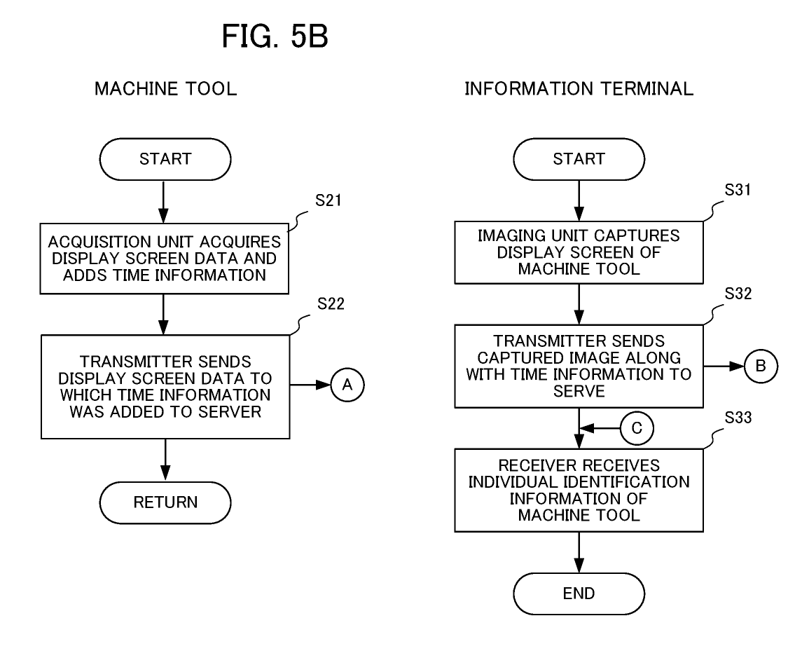

Next, the operational flow of the system 1 will be explained while referencing FIGS. 5A and 5B. FIG. 5 is a view showing the operational flow of the system 1.

First, the operational flow of the server 10 will be described in detail using FIG. 5A.

In Step S11, the accumulating unit 111 of the server 10 collects display screen data to which the time information was attached from the machine tool 20, for comparing with the captured image capturing the display screen of the machine tool 20 and sent to the server 10 by the information terminal 30 for specifying the individual identification information of the machine tool 20, and then accumulates in the storage unit 102.

In Step S12, the server 10 stands by for a predetermined time interval.

In Step S13, in the case of the receiver 112 of the server 10 having received the captured image of the display screen of the machine tool 20 to which the time information was added from the information terminal 30 (Step S13: YES), the processing advances to Step S14. In the case of not having received a captured image of the display screen of the machine tool 20 to which time information was added (Step S13: NO), the processing returns to Step S11.

In Step S14, the comparison unit 113 of the server 10 compares between the captured image of the display screen of the machine tool 20 received from the information terminal 30 by the receiver 112, and the display screen data collected from each machine tool 20 by the accumulating unit 111. This display screen data has time information of the same time or within a fixed range of the time information of the captured image of the display screen of the machine tool 20.

In Step S15, in the case of the comparison unit 113 of the server 10 being able to specify the machine tool which is the photographing target of the captured image received from the information terminal 30 as a result of the above-mentioned comparison (Step S15: YES), the processing advances to Step S16. In the case of not being able to specify the machine tool which is the photographing target of the captured image received from the information terminal 30 (Step S15: NO), the processing returns to Step S12. Herein, as cases of not being able to specify the machine tool corresponding to the captured image received from the information terminal 30, for example, a case of display screen data matching the captured image not existing, and a case of a plurality of display screen data matching the captured image existing and not being able to specify as one, can be exemplified. Especially for the latter case, upon returning to Step S12, the user may manually switch the display screen of the machine tool 20 for which specification of the individual identification information is desired, capture the display screen by the information terminal 30 again, then send this captured image to the server 10, and the comparison unit 113 of the server 10 may compare between the captured image and display screen data again.

In Step S16, the transmitter 114 of the server 10 sends the individual identification information of the machine tool 20 specified as a result of comparison by the comparison unit 113 to the information terminal 30, and the processing returns to Step S11.

Next, the operational flow of the machine tool 20 and information terminal 30 will be described in detail using FIG. 5B. First, the operational flow of the machine tool 20 will be explained.

In Step S21, the acquisition unit 211 acquires the display screen data of the machine tool 20 from the display screen control unit (not illustrated), and adds time information to this display screen data. This display screen data is for use in comparison with the captured image by the comparison unit 113 of the server 10.

In Step S22, the transmitter 212 of the machine tool 20 sends the display screen data to which the time information was added, acquired from the display screen control unit (not illustrated) by the acquisition unit 211 to the server 10, and the processing returns to Step S21.

Next, the operational flow of the information terminal 30 will be explained.

In Step S31, the imaging unit 311 of the information terminal 30 captures the display screen of the machine tool 20 for which the user intends specifying of the individual identification information.

In Step S32, the transmitter 312 of the information terminal 30 sends the captured image of the display screen of the machine tool 20 to which time information was added to the server 10.

In Step S33, the receiver 313 of the information terminal 30 receives the individual identification information of the machine tool 20 corresponding to the captured image of the display screen of the machine tool 20, specified by the comparison unit 113 of the server 10.

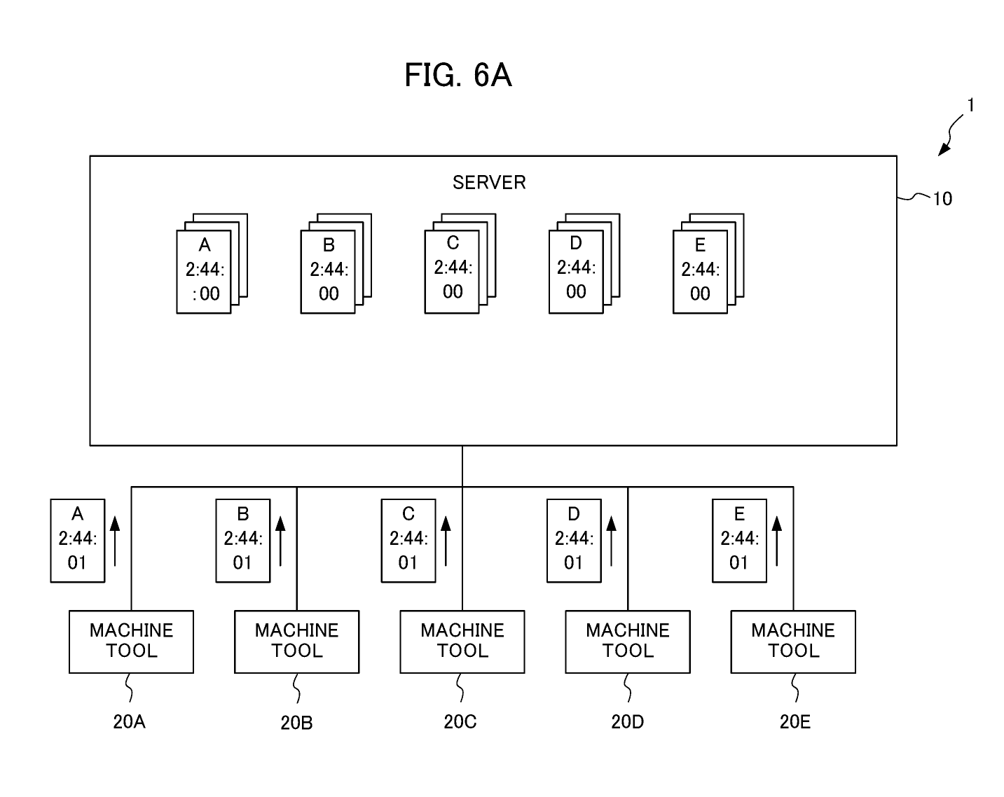

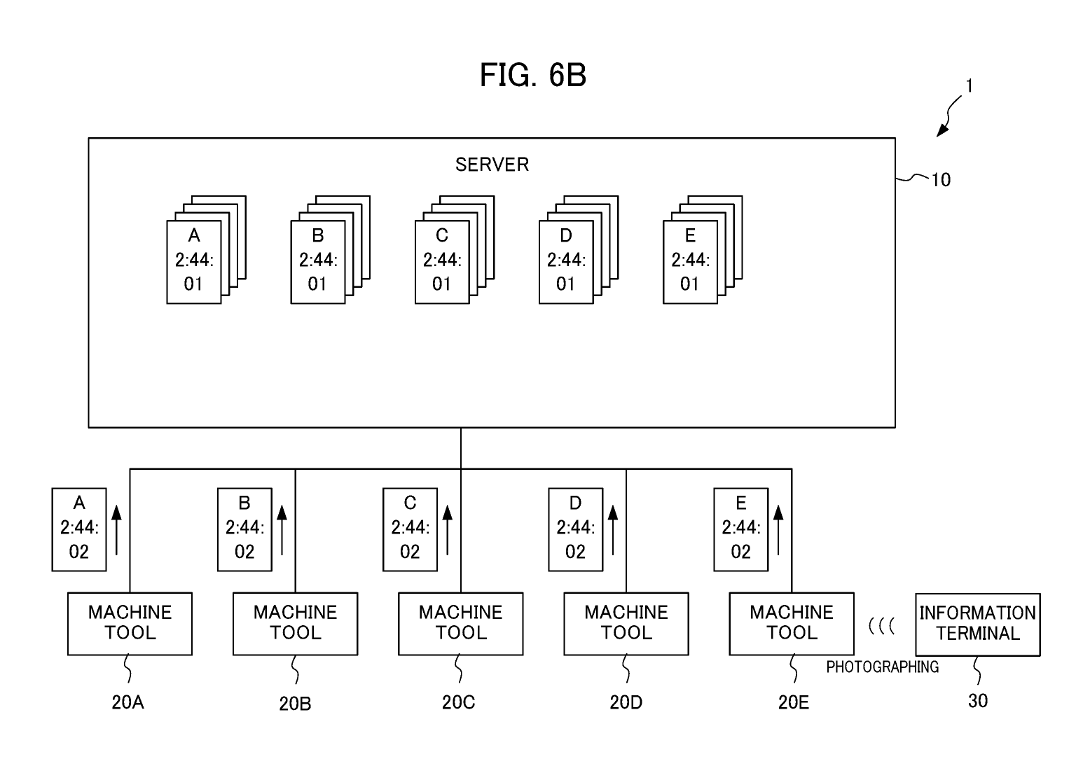

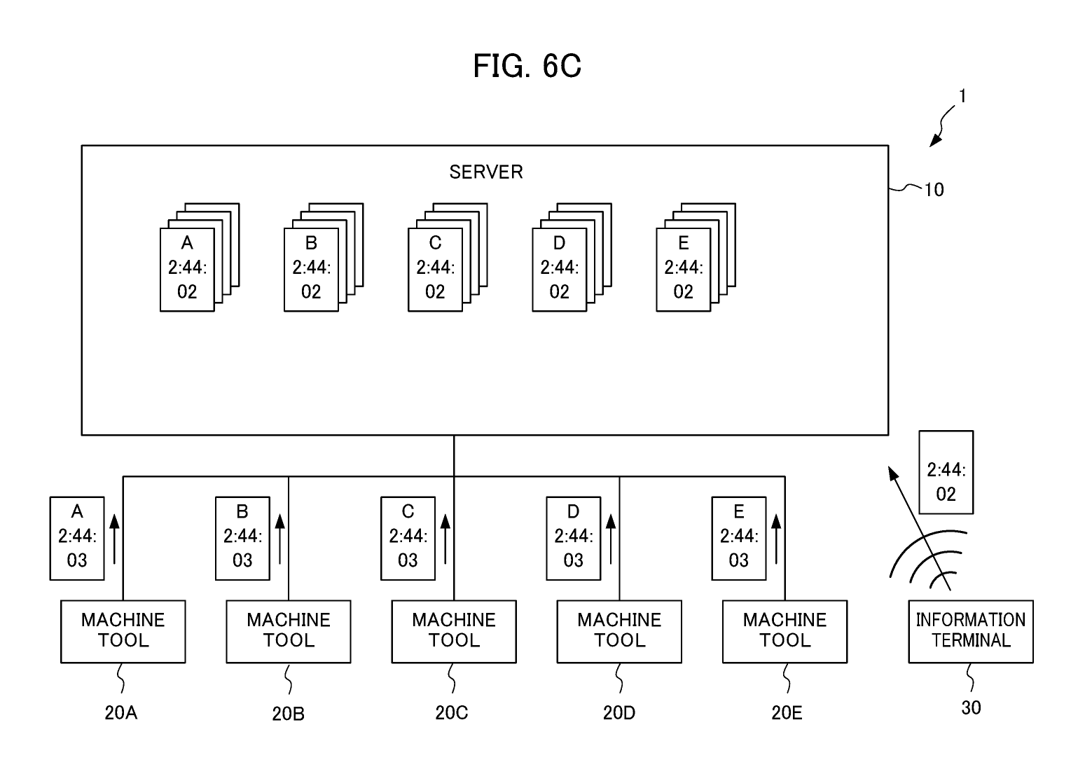

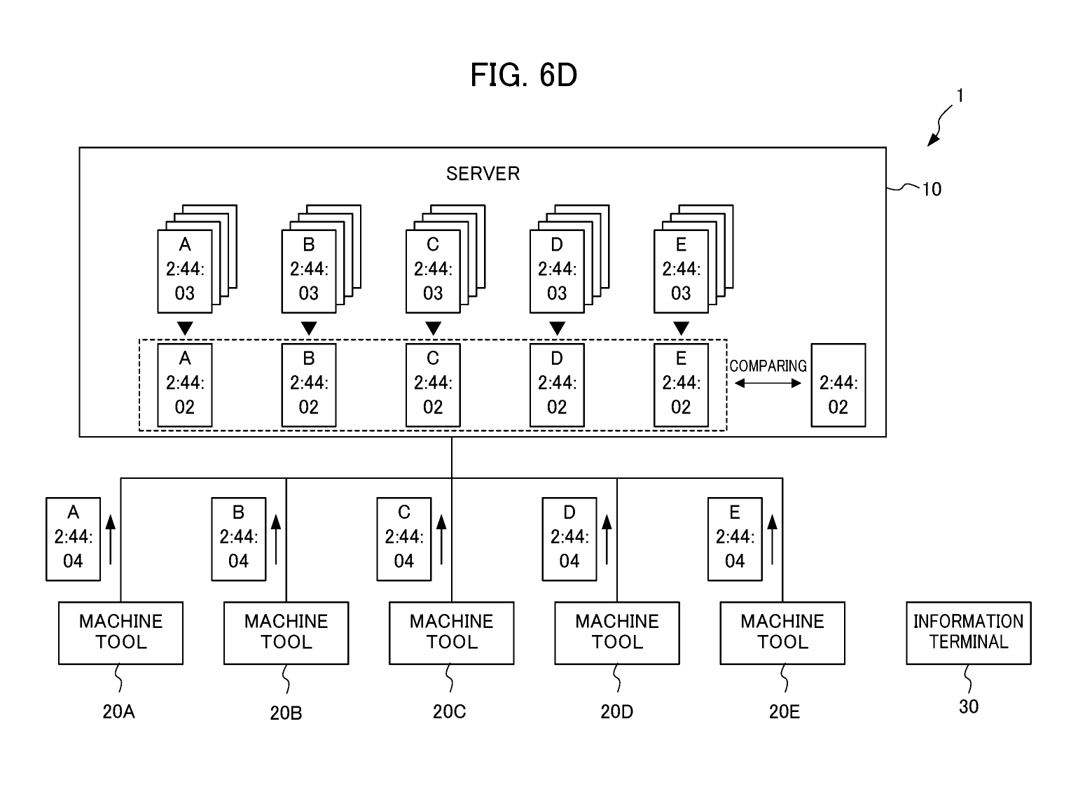

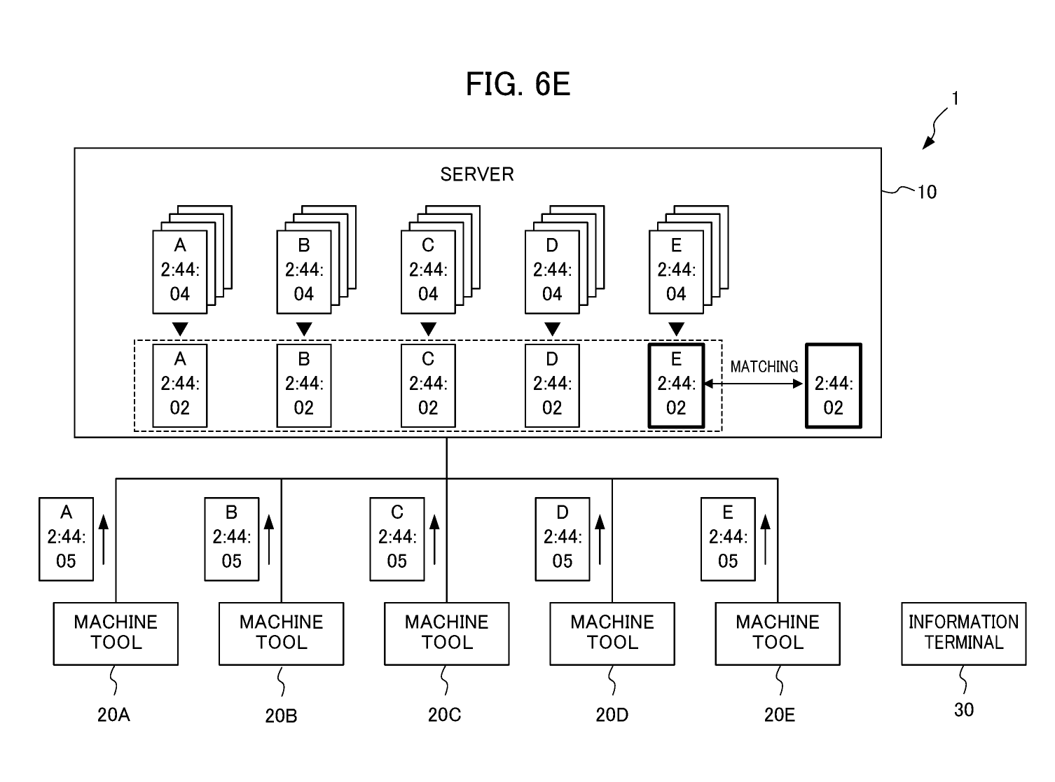

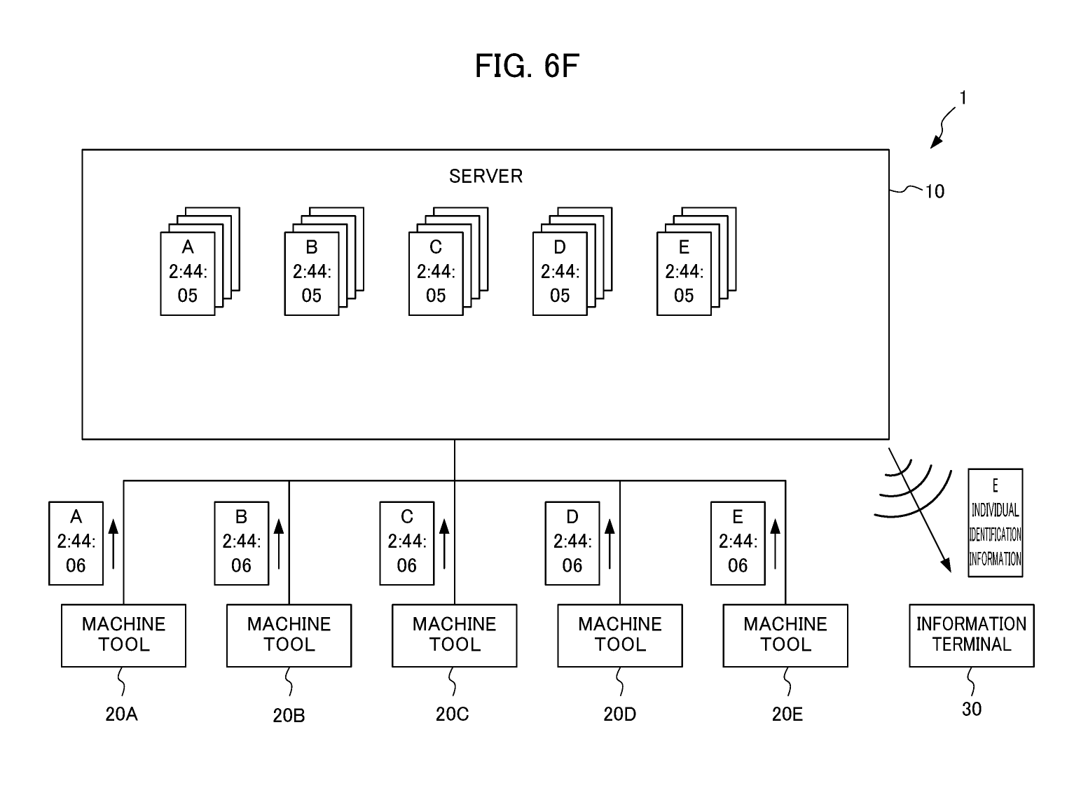

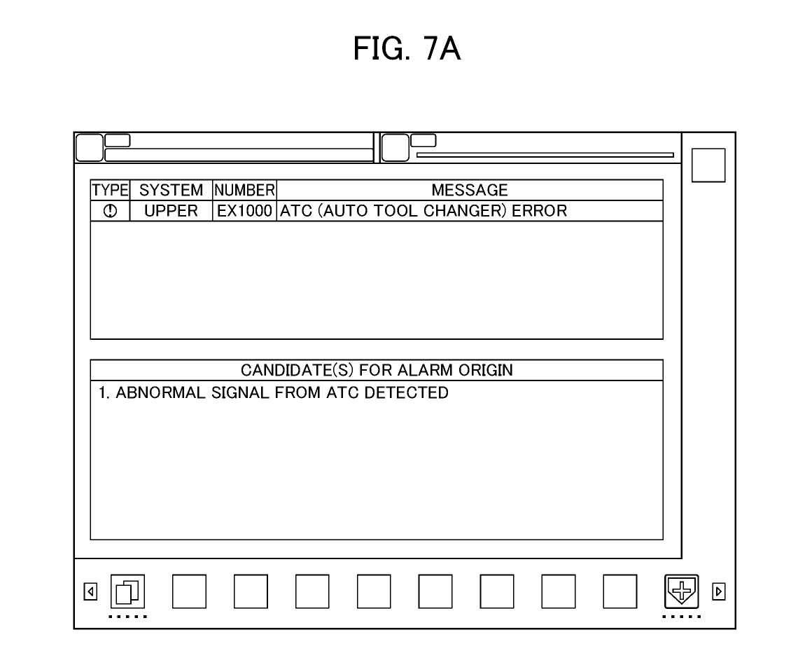

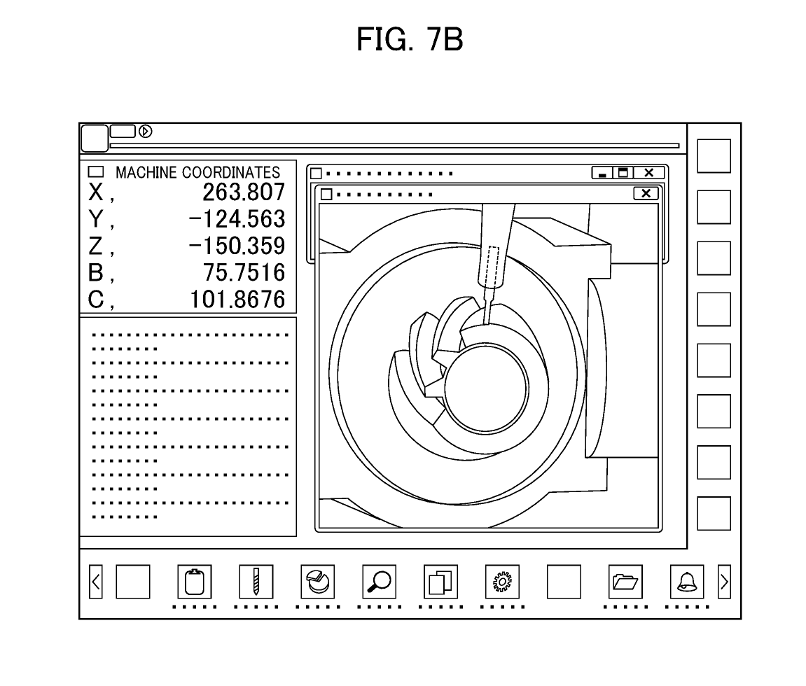

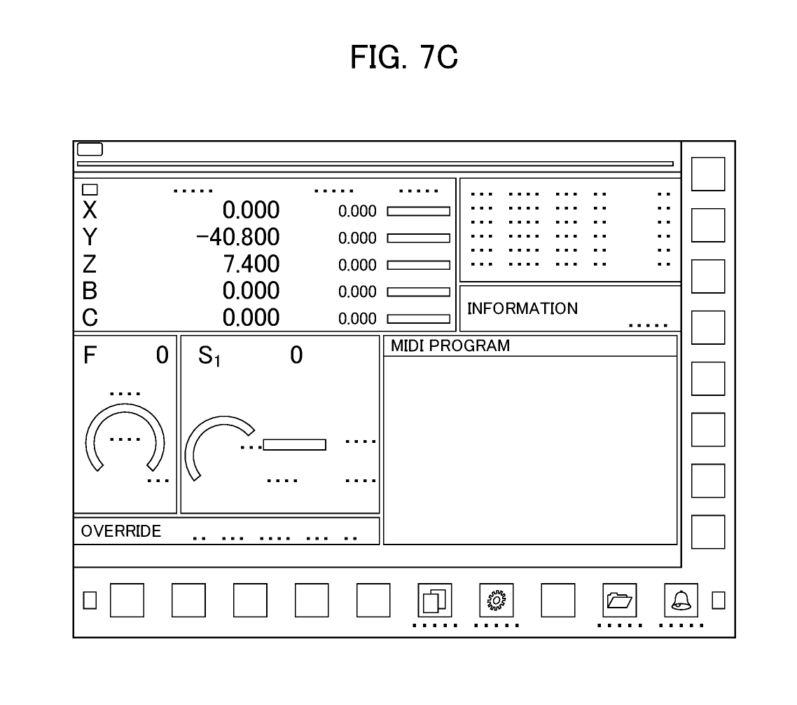

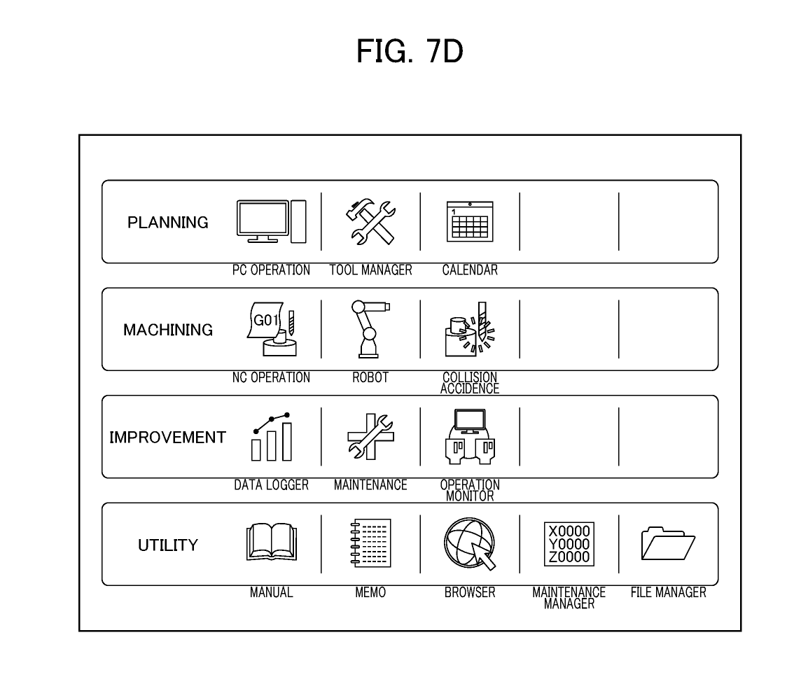

The above is the operational flow of the server 1. Next, specific examples of the above-mentioned operational flow will be described in detail using FIGS. 6A to 7D.

In FIG. 6A, in the storage unit 102 of the server 10, the display screen data of machine tools 20A to 20E until time 2:44:00 is accumulated. The acquisition unit 211 of each of the machine tools 20A to 20E acquires the display screen data of its own machine tool 20, and the transmitter 212 sends the display screen data of time 2:44:01 to the server 10 via a network.

In FIG. 6B, the imaging unit 311 of the information terminal 30 captures the display screen of the machine tool 20E at the moment of time 2:44:02. Also during this period, the acquisition unit 211 of each of the machine tools 20A to 20E acquires the display screen data of its own machine tool 20, the transmitter 212 sends the display screen data to the server 10, and the display screen data continues to be accumulated in the storage unit 102 of the server 10; however, explanation thereof will be omitted below.

In FIG. 6C, the transmitter 312 of the information terminal 30 sends the captured image of the display screen of the machine tool 20 at the moment of the above-mentioned time 2:44:02 to the server 10.

In FIG. 6B, the comparison unit 113 of the server 10 compares the captured image having the time information of the above-mentioned time 2:44:02, with the display screen data of each machine tool having the time information of the time 2:44:02.

In FIG. 6E, as a result of the above-mentioned comparison, the captured image having the time information of the time 2:44:02 is supposed as matching with the display screen data of the machine tool 20E having the time information of the time 2:44:02. The comparison unit 113 of the server 10 thereby specifies that the machine tool corresponding to the captured images of the display screen of the machine tool 20 is 20E.

In FIG. 6F, the transmitter 114 of the server 10 sends the individual identification information of the machine tool 20E to the information terminal 30.

The information terminal 30 can thereby acquire the individual identification information of the machine tool 20E that was sent from the transmitter 114 of the server 10. By using this individual identification information of the machine tool 20E, the user is able to employ the individual information of the machine tool 20E stored in the storage unit 102 of the server 10, and associated with the individual identification information of the machine tool 20E.

As described in the explanation of the specific example using the above-mentioned FIGS. 6A to 6F, the transmitter 212 of each of the machine tools 20A to 20F sends the display screen data to the server 10; however, this example of display screen data is shown in FIGS. 7A to 7D.

FIG. 7A is a screen for conveying information of the machine tool. FIG. 7B is a screen showing a processing simulation. FIG. 7C is a screen displayed upon the machine tool making an MDI operation. FIG. 7D is a home screen. For these images, the features of the image greatly differ from each other as understood at first glance. For example, in the display screen data of FIG. 7A, two horizontally elongated rectangles are aligned vertically. In the display screen data of FIG. 7B, two rectangles showing various numerical values are aligned vertically at the left side of the screen, and a rectangle showing an aspect of processing simulation is present at the right side of the screen. In the display screen data of FIG. 7C, the two rectangles showing various numerical values are aligned at the left and right at the top of the screen, and three rectangles are aligned horizontally at the bottom of the screen. In the display screen data of FIG. 7D, horizontally elongated rectangles corresponding to menus of the major categories of “PLANNING”, “MACHINING”, “IMPROVEMENT” and “UTILITY” are aligned longitudinally, and each rectangle is partitioned into five transversely for every menu of sub-categories.

Herein, for example, a case is assumed in which, to the server 10, display screen data shown in FIG. 7A is sent from the machine tools 20A and 20B, the display screen data shown in FIG. 7B is sent from the machine tools 20C and 20D, and the display screen data shown in FIG. 7C is sent from the machine tool 20E. At this time, the captured image of a display screen similar to FIG. 7C is sent to the server 10 from the information terminal 30 having captured the display screen of the machine tool 20E. Since the display screen data having a feature and feature value matching this captured image is the display screen data of the machine tool 20E, the comparison unit 113 of the server 10 specifies that the machine tool corresponding to the captured image of the display screen of the machine tool 20 is the machine tool 20E.

Assuming a case of the display screen data shown in FIG. 7C being sent to the server 10 from not only the machine tool 20E, but also the machine tool 20D, the display screen data having features and a feature value matching the above-mentioned captured image will not be limited to one, and it will not be possible to specify the machine tool corresponding to the captured image. In this case, the user manually switches the display screen of the machine tool 20E to the home screen shown in FIG. 7D, and by conducting capturing of the display screen of the machine tool 20E by way of the imaging unit 311 of the information terminal 30 and sending of the captured image to the server 10 by the transmitter 312 again, it is specified that the machine tool captured by oneself is the machine tool 20E.

### <1.6 Effects of First Embodiment>

As mentioned above, a user not knowing the individual identification information of a machine tool can specify the individual identification information of the machine tool by simply capturing the display screen by an information terminal, and sending the captured image to the server. The user can know the individual information stored in the storage unit of the server and associated with the individual identification information by using this individual identification information. Individual information, for example, is the model number, maker, installation location, installation date, service parts information of the machine tool, information of a tool set in the machine tool, information of a workpiece set in the machine tool, machining schedule information, machining results information, IP address, numerical control information, amplifier information, motor information, sensor information, machining program information, etc. used in the machine tool.

### 2. Second Embodiment

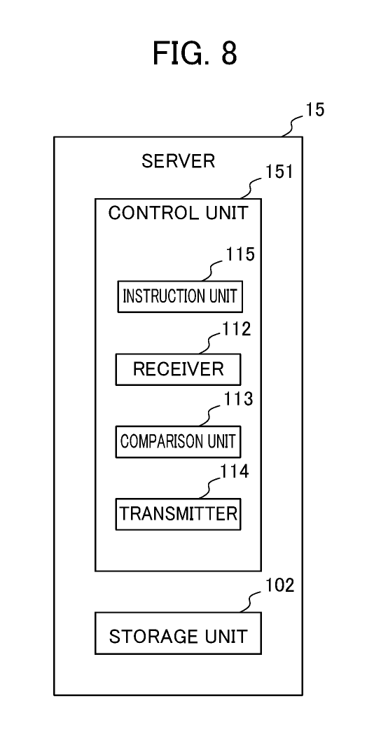

Hereinafter, a second embodiment of the present invention will be described in detail while referencing FIGS. 8 to 11F.

### <2.1 Configuration of Invention>

A system 2 according to the second embodiment of the present invention, when compared with the system 1 according to the first embodiment, is identical except for the server 10 being transposed with the server 15 described later, and the machine tool 20 being transposed with the machine tool 25 described later.

### <2.2 Regarding Server>

The configuration of the server 15 of the second embodiment is shown in FIG. 8. It should be noted that the same reference symbols are used for constituent elements which are identical to the server 10 of the first embodiment, and explanations thereof will be omitted.

Contrary to the server 10 of the first embodiment, the server 15 has an instruction unit 115 in place of the accumulating unit 111.

The instruction unit 115 instructs, to the machine tools 25, the sending of display screen data having time information of the same time or within a fixed range of the time information of the captured image of the display screen of the machine tool 25 which the user intends specifying of the individual identification information, received from the information terminal 30.

### <2.3 Regarding Machine Tool>

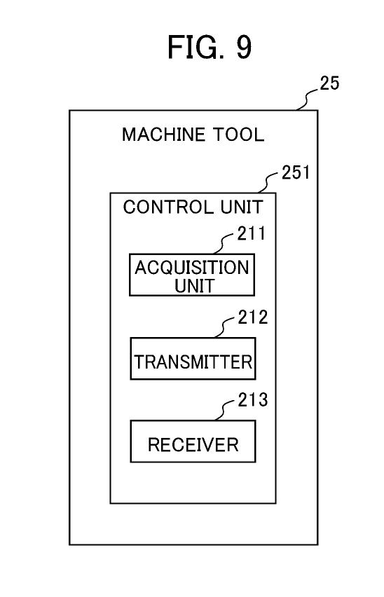

FIG. 9 shows the configuration of the machine tool 25 of the second embodiment. It should be noted that the same reference symbols are used for constituent elements which are identical to the machine tool 20 of the first embodiment, and explanations thereof will be omitted.

Contrary to the machine tool 20 of the first embodiment, the machine tool 25 has a receiver 213, in addition to the acquisition unit 211 and transmitter 212.

The receiver 213 receives a sending instruction of the display screen data of its own machine tool 25 from the server 15. It should be noted that, in response to receiving of this sending instruction, the acquisition unit 211 acquires display screen data for use in comparison with the captured image by the server 15, from the display screen control unit (not illustrated) of this machine tool 25. Subsequently, the transmitter 212 sends display screen data of each machine tool 25 acquired by the acquisition unit 211 to the server 15.

### <2.4 Regarding Information Terminal>

The information terminal 30 possessed by the system 2 according to the second embodiment is identical with the information terminal 30 of the system 1 according to the first embodiment. For this reason, an explanation of the configuration of the information terminal 30 will be omitted.

### <2.5 Regarding Operation>

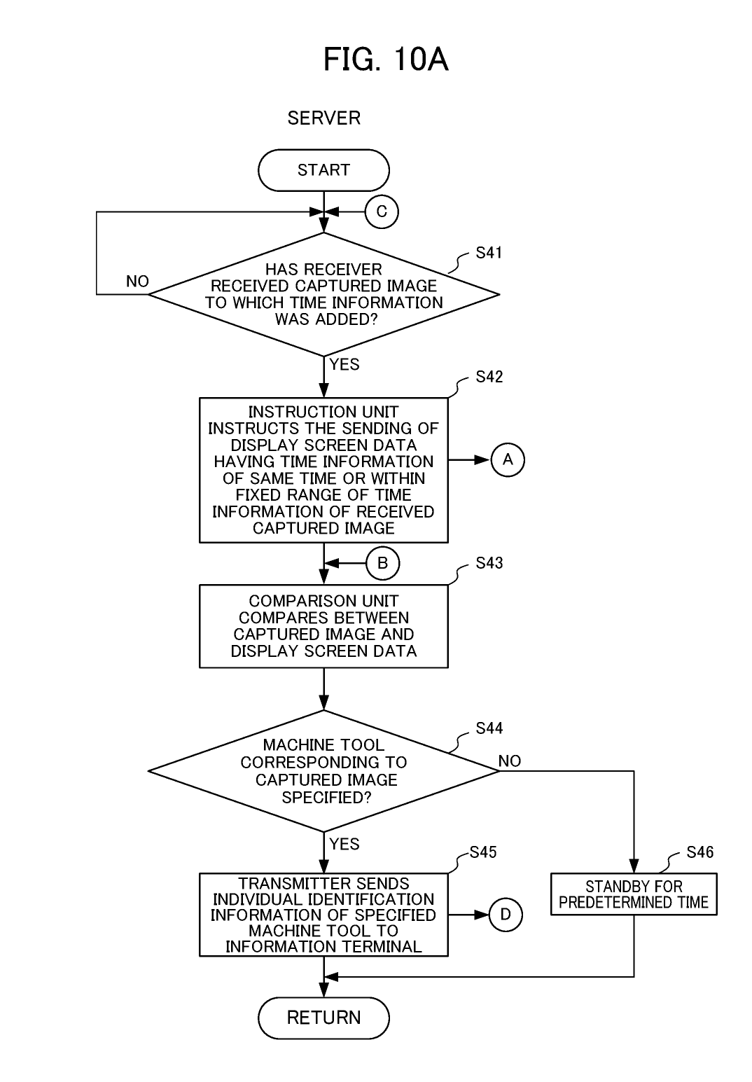

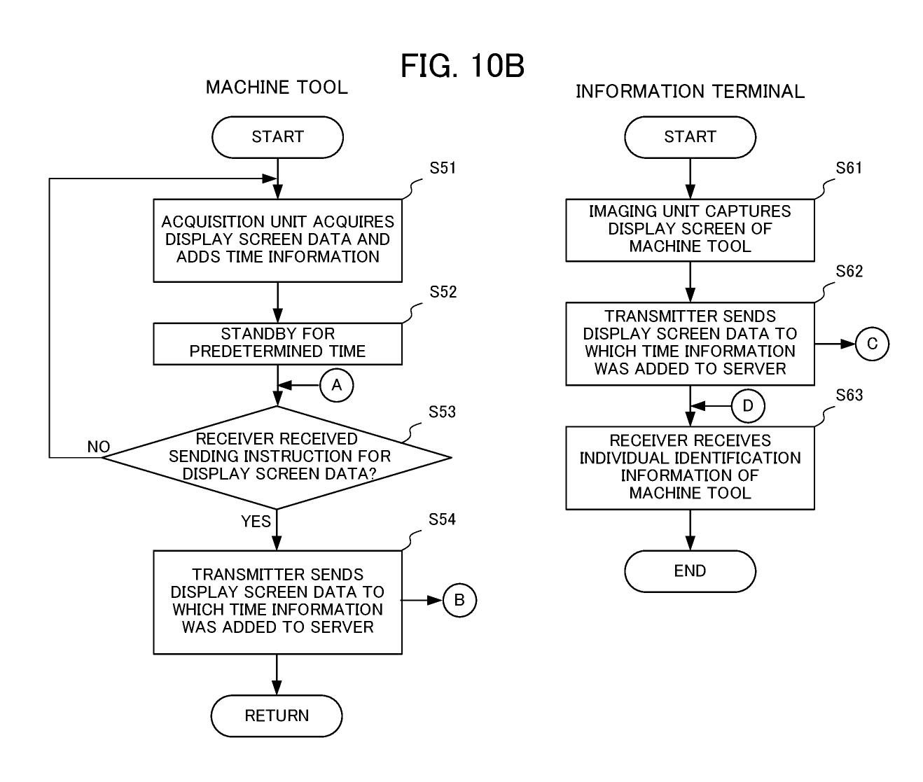

Next, the operational flow of the system 2 will be explained while referencing FIGS. 10A and 10B. FIG. 10 is a view showing the operational flow of the system 2.

First, the operational flow of the server 15 will be described in detail using FIG. 10A.

In Step S41, in the case of the receiver 112 of the server 15 receiving a captured image to which time information was added from the information terminal 30 (Step S41: YES), the processing advances to Step S42. In the case of the receiver of the server 15 not receiving a captured image to which time information was added from the information terminal 30 (Step S41: NO), the processing returns to Step S41. It should be noted that this captured image is capturing the display screen of the machine tool 25 by the information terminal 30, and sent to the server 10, in order to specify the individual identification information of the machine tool 25.

In Step S42, the instruction unit 115 of the server 15 instructs, to the machine tool 25, the sending of the display screen data having time information of the same time or within a fixed range of the time information of the received captured image.

In Step S43, the comparison unit 113 of the server 15 compares between the captured image of the display screen of the machine tool 25 received by the receiver 112 from the information terminal 30, and the display screen data sent from the machine tools 25.

In Step S44, in the case of the comparison unit 113 of the server 15 being able to specify the machine tool 25 corresponding to the captured image of the display screen as a result of the above-mentioned comparison (Step S44: YES), the processing advances to Step S45. In the case of not being able to specify the machine tool 25 corresponding to the captured image (Step S44: NO), the processing advances to Step S46. Herein, as cases of not being able to specify the machine tool corresponding to the captured image, for example, a case of display screen data matching the captured image not existing, and a case of a plurality of display screen data matching the captured image existing and not being able to specify as one, can be exemplified. Especially for the latter case, upon advancing to Step S46, the user may manually switch the display screen of the machine tool 25 for which specification of the individual identification information is desired, capture the display screen by the information terminal 30 again, then send this captured image to the server 15, and the comparison unit 113 of the server 15 may compare between the captured image and display screen data again.

In Step S45, the transmitter 114 of the server 15 sends the individual identification information of the machine tool 25 specified by the comparison unit 113 to the information terminal 30, and the processing returns to Step S41.

In Step S46, the server 15 stands by for a predetermined time interval, and the processing returns to Step S41.

Next, the operational flow of the machine tool 25 and information terminal 30 will be described in detail using FIG. 10B. First, the operational flow of the machine tool 25 will be explained.

In Step S51, the acquisition unit 211 of the machine tool 25 acquires display screen data of the machine tool 25 for use in comparison with the captured image by the comparison unit 113 of the server 15 from the display screen control unit (not illustrated), and adds time information to this display screen data.

In Step S52, the machine tool 25 stands by for a predetermined time interval.

In Step S53, in the case of the receiver 213 of the machine tool 25 having received a sending instruction for display screen data from the server 15 (Step S53: YES), the processing advances to Step S54. In the case of not receiving a sending instruction for display screen data from the server 15 (Step S53: NO), the processing returns to Step S51.

In Step S54, the transmitter 212 of the machine tool sends, to the server 15, the display screen data acquired from the display screen control unit by the acquisition unit 211 and having time information of the same time or within a fixed range from the time designated by the display screen data sending instruction, and the processing returns to Step S51.

Next, the operational flow of the information terminal 30 will be explained.

In Step S61, the imaging unit 311 of the information terminal 30 captures the display screen of the machine tool 25 for which the user intends specifying of the individual identification information.

In Step S62, the transmitter 312 of the information terminal 30 sends, to the server 15, the captured image of the display screen of the machine tool 25 to which time information was added.

In Step S63, the receiver 313 of the information terminal 30 receives the individual identification information of the machine tool 25 corresponding to the captured image specified by the comparison unit 113 of the server 15.

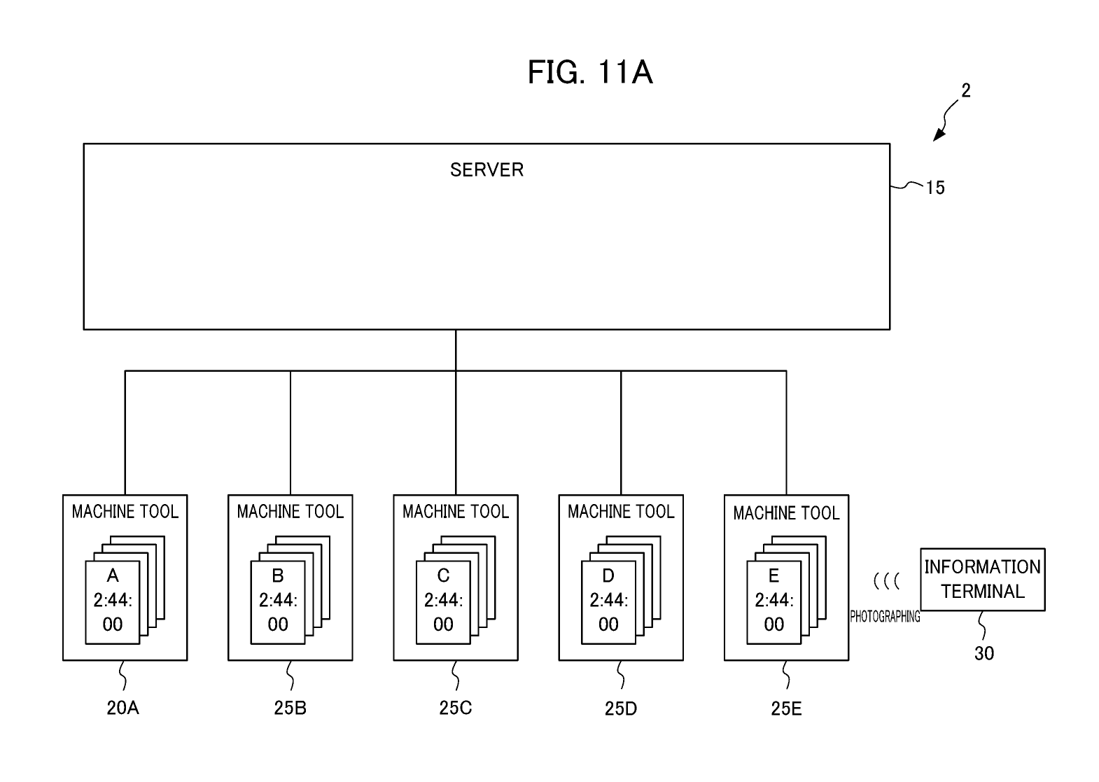

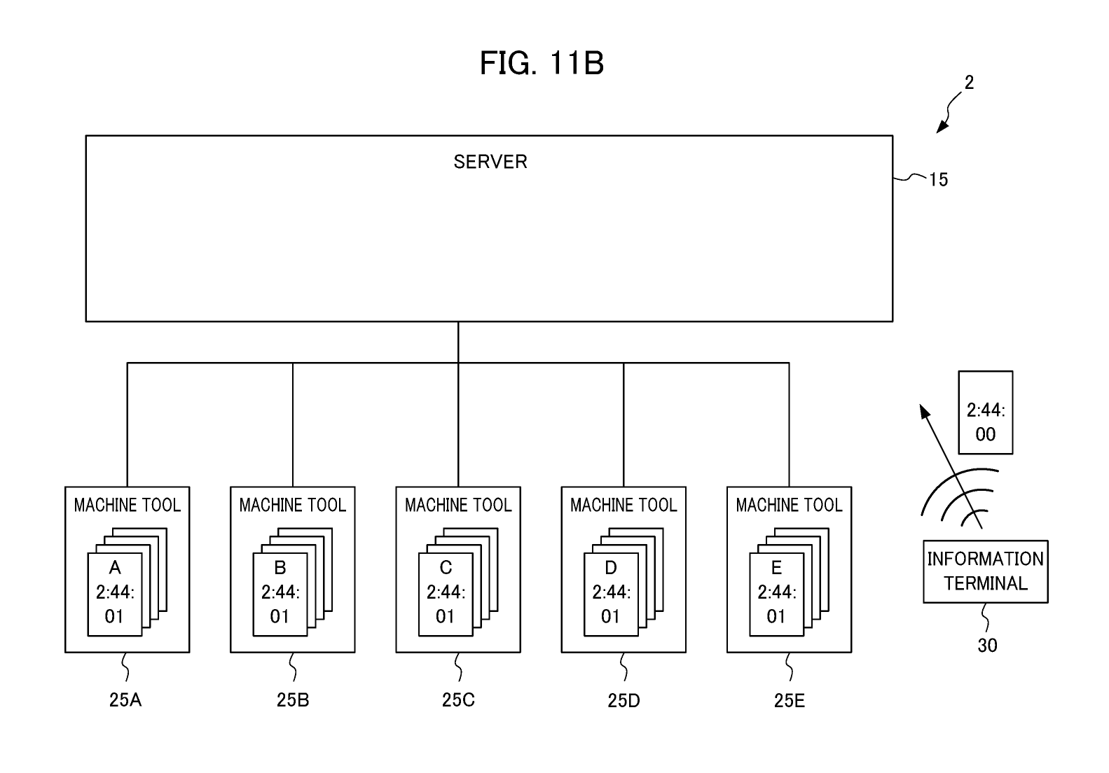

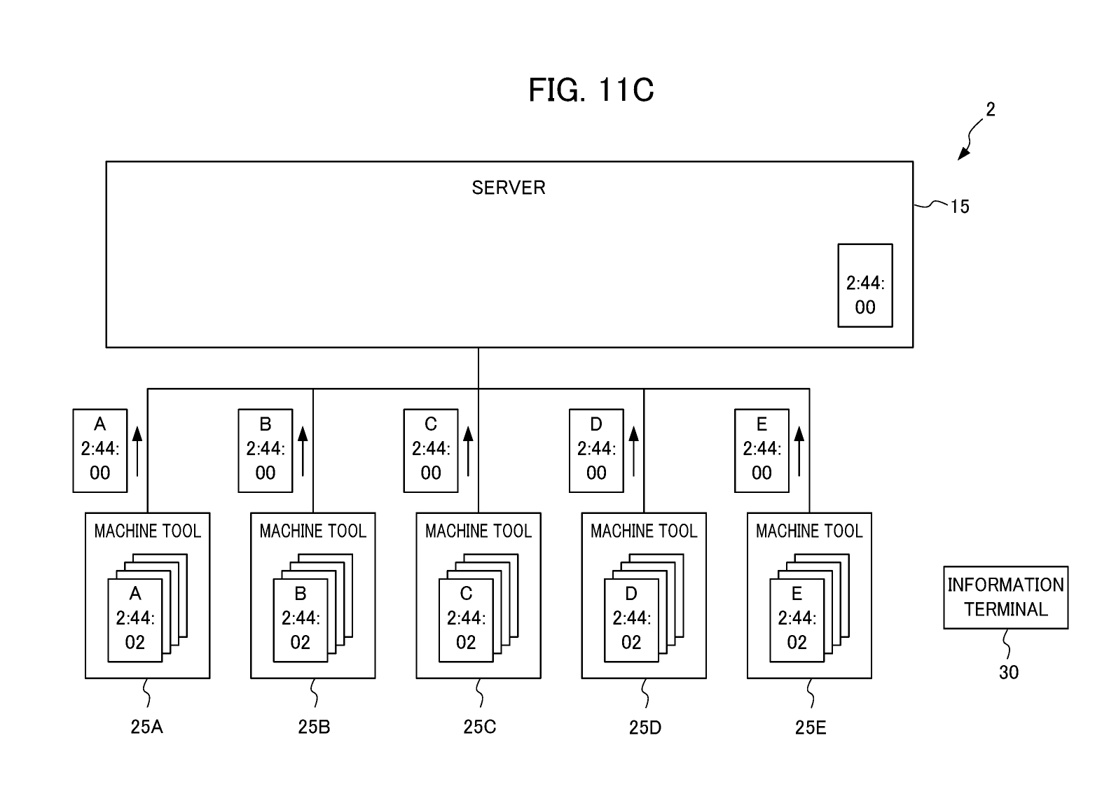

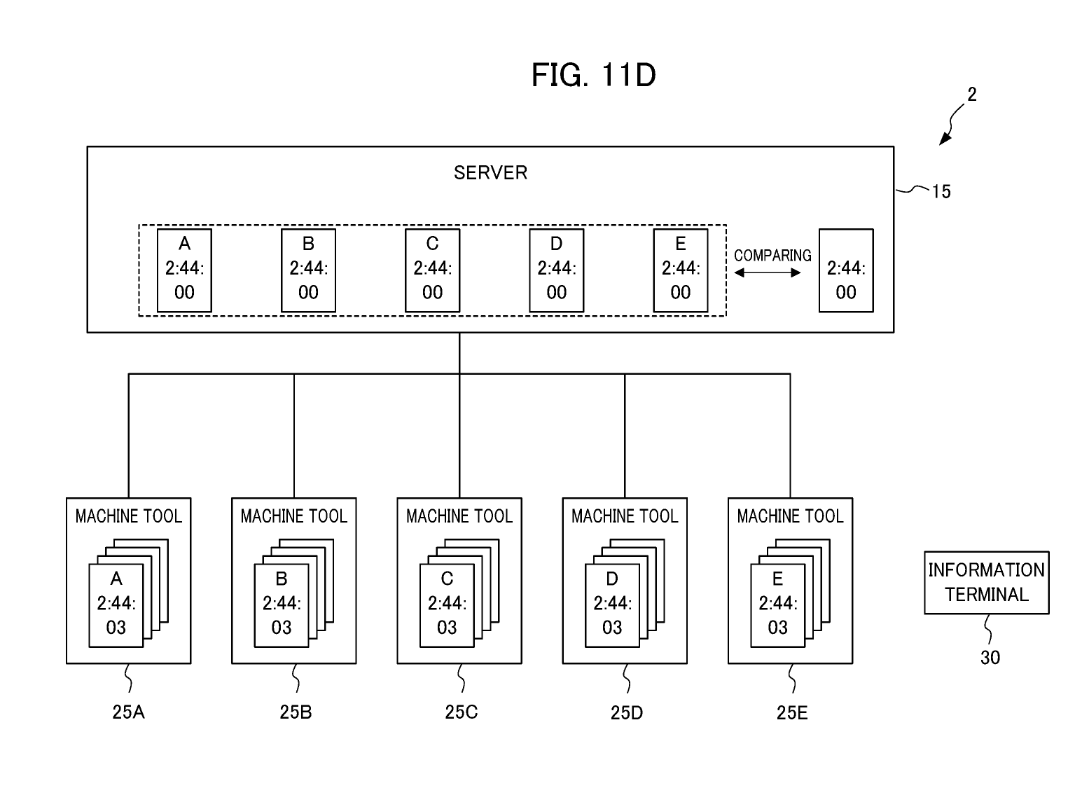

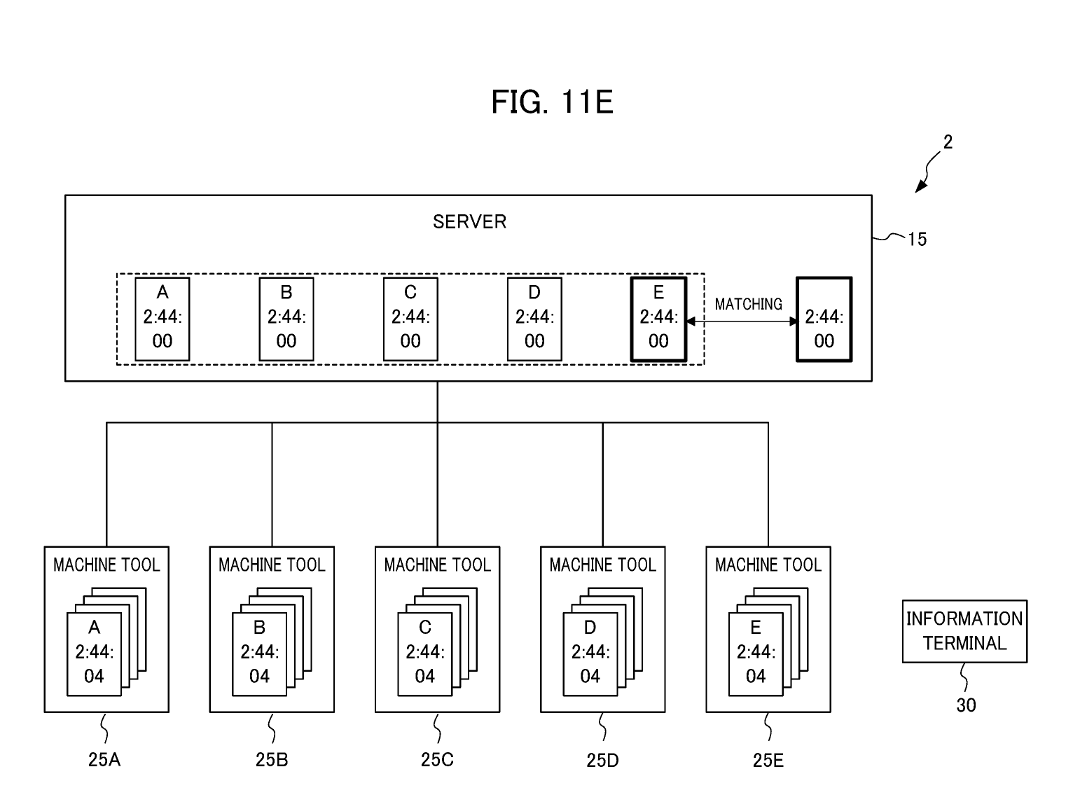

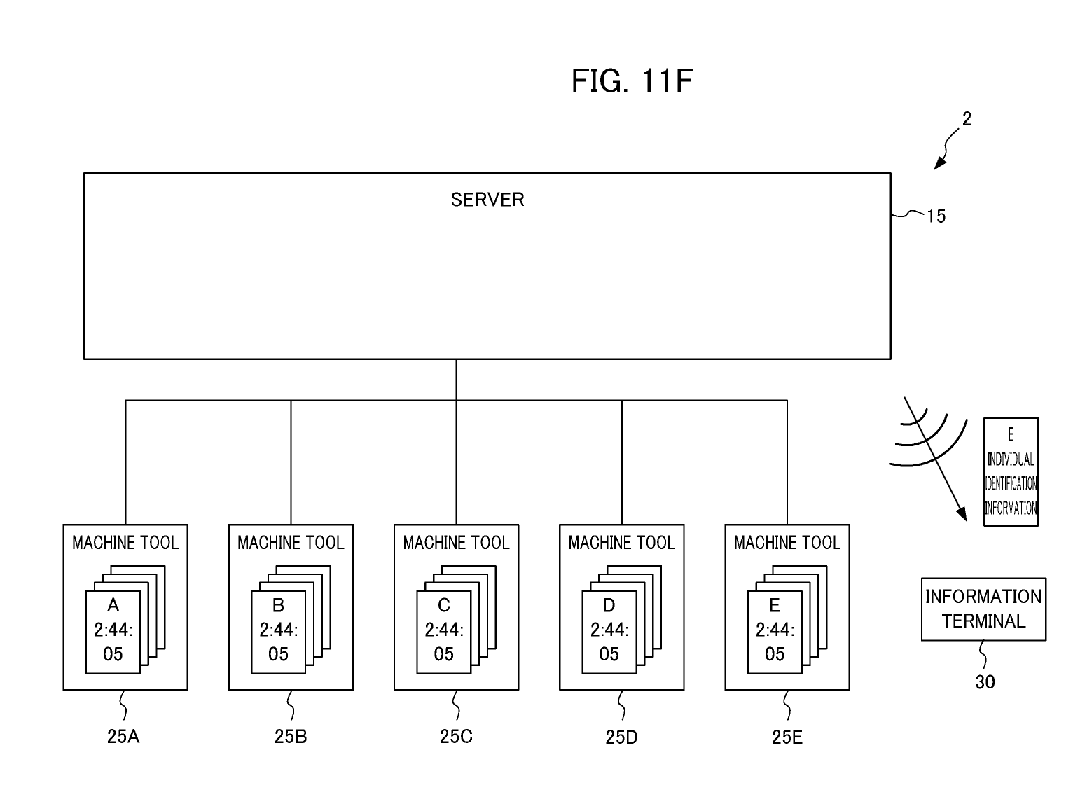

The above is the operational flow of the system 2. Next, a specific example of the above-mentioned operational flow will be described in detail using FIGS. 11A to 11F.

In FIG. 11A, the display screen data until time 2:44:00 is accumulated in the storage unit 252 (not illustrated) of the machine tool 25. Herein, the imaging unit 311 of the information terminal 30 captures the display screen of the machine tool 25E at the moment of time 2:44:00.

In FIG. 11B, the transmitter 312 of the information terminal 30 sends the captured image at the moment of the above-mentioned time 2:44:00 to the server 15. Also during this period, the display screen data is accumulated in the machine tools 25A to 25E by the acquisition unit 211 of each of the machine tools 25A to 25E acquiring the display screen data of its own machine tool 25; however, explanations thereof afterwards will be omitted.

In FIG. 11C, the receiver 112 of the server 15 receives the captured image having the time information of the time 2:44:00 from the information terminal 30, and the instruction unit 115 of the server 15 instructs the sending of display screen data having the time information of time 2:44:00 to the machine tools 25. In response thereto, the transmitters 212 of the machine tools 25 send the display screen data for the moment of time 2:44:00 to the server 15.

In FIG. 11D, the comparison unit 113 of the server 15 compares the captured image of the display screen of the machine tool 25 having the time information of the above-mentioned time 2:44:00, with the display screen data of each machine tool having time information of time 2:44:00.

In FIG. 11E, as a result of the above-mentioned comparison, the captured image having the time information of time 2:44:00 is supposed as matching with the display screen data of the machine tool 25E having the time information of time 2:44:00. The comparison unit 113 of the server 15 thereby specifies the machine tool corresponding to the captured image of the display screen of the machine tool 25, which is the comparison target, as being 25E.

In FIG. 11F, the transmitter 114 of the server 15 sends the individual identification information of the machine tool 25 to the information terminal 30.

The information terminal 30 can thereby acquire the individual identification information of the machine tool 25E which was sent from the transmitter 114 of the server 15. By using the individual identification information of this machine tool 25E, the user becomes able to use individual information stored in the storage unit 102 of the server 15 and associated with the individual identification information of the machine tool 25E.

### <2.6 Effects of Second Embodiment>

Similarly to the first embodiment as mentioned above, a user not knowing the individual identification information of a machine tool can specify the individual identification information of the machine tool, by simply capturing the display screen by an information terminal, and sending the captured image to the server. By using this individual identification information, the user can know individual information stored in the storage unit of the server and associated with the individual identification information. Individual information, for example, is the model number, maker, installation location, installation date, service parts information of the machine tool, information of a tool set in the machine tool, information of a workpiece set in the machine tool, machining schedule information, machining results information, IP address, numerical control information, amplifier information, motor information, sensor information, machining program information, etc. used in the machine tool.

### 3. Modified Example

In the first embodiment, the accumulating unit 111 of the server 10 collects display screen data at 1-second intervals from machine tools 20; however, the embodiments of the present invention are not limited thereto, and it is possible to collect display screen data at an arbitrary time interval.

In addition, in the first embodiment, the accumulating unit 111 of the server 10 collects display screen data from the machine tools 20 at predetermined time intervals; however, the embodiments of the present invention are not limited thereto. For example, the machine tools 20 may send the display screen data to which time information was added at predetermined intervals to the server 10 autonomously.

In addition, in the first and second embodiments, upon the acquisition unit 211 of the machine tool 20 or 25 acquiring display screen data, the acquisition unit 211 itself adds the time information to this display screen data. However, the embodiments of the present invention are not limited thereto. For example, display screen data to which time information is not added may be sent from the machine tool 20 or 25 to the server 10 or 15, and time information may be added on the side of the server 10 or 15 to the received display screen data based on its own clock unit. Furthermore, a captured image to which time information is not added may be sent from the information terminal 30 to the server 10 or 15, and time information may be added to the received captured image on the side of the server 10 or 15 based on its own clock unit.

In each of the above-mentioned embodiments, a method for recognizing the individual identification information of a machine executed by systems 1 and 2 and servers 10 and 15 is realized by software. In the case of being realized by software, programs constituting this software are installed to a computer (servers 10 and 15). In addition, these programs may be recorded on removable media and distributed to the user, or may be distributed by being downloaded to a user's computer via a network.

### EXPLANATION OF REFERENCE NUMERALS

1, 2 system
10, 15 server
20, 25 machine tool
30 information terminal
101, 151, 201, 251, 301 control unit
102 storage unit
111 accumulating unit
112 receiver
113 comparison unit
114 transmitter
115 instruction unit
211 acquisition unit
212 transmitter
213 receiver
311 imaging unit
312 transmitter
313 receiver

What is claimed is:

1. A server communicable with a plurality of machine tools via a network, the server comprising a control unit and a storage unit,
wherein the control unit comprises:
an accumulating unit that collects display screen data from the machine tool at a predetermined time interval, and accumulates the display screen data in the storage unit along with time information and individual identification information of the machine tool;
a receiver that receives a captured image of a display screen of a machine tool sent from an information terminal;
a comparison unit that conducts a comparison between the captured image of the display screen of the machine tool received from the information terminal, and the display screen data accumulated in the storage unit, and specifies the display screen data that is matching; and
a transmitter that transmits individual identification information of a specified machine tool as a result of the comparison to the information terminal.

2. A server communicable with a plurality of machine tools via a network, the server comprising a control unit and a storage unit,
wherein the control unit comprises:
a receiver that receives a captured image of a display screen of a machine tool sent from an information terminal;
an instruction unit that instructs sending of display screen data to the machine tool when receiving the captured image from the information terminal, and collects the display screen data along with time information and individual identification information of the machine tool;
a comparison unit that conducts a comparison between the captured image of the display screen of the machine tool received from the information terminal and the display screen data collected by the instruction unit, and specifies the display screen data that is matching; and
a transmitter that transmits individual identification information of a specified machine tool as a result of the comparison to the information terminal.

3. A method executed by a server communicable with a plurality of machine tools via a network, the method comprising the steps of:
collecting display screen data from the machine tool at a predetermined time interval, and accumulating the display screen data in a storage unit along with time information and individual identification information of the machine tool;
receiving a captured image of a display screen of a machine tool sent from an information terminal;
comparing between the captured image of the display screen of the machine tool received from the information terminal and the display screen data accumulated in the storage unit, and specifying the display screen data that is matching; and
sending individual identification information of a specified machine tool as a result of the comparing to the information terminal.

4. A method executed by a server communicable with a plurality of machine tools via a network, the method comprising the steps of:
receiving a captured image of a display screen of a machine tool sent from an information terminal;
instructing sending of display screen data to the machine tool when receiving the captured image from the information terminal, and collecting the display screen data along with time information and individual identification information of the machine tool;
comparing between the captured image of the display screen of the machine tool received from the information terminal and the display screen data collected in the step of instructing, and specifying the display screen data that is matching; and
sending individual identification information of a specified machine tool as a result of the comparing to the information terminal.

5. A non-transitory computer-readable medium encoded with a program for causing a computer to function as a server communicable with a plurality of machine tools via a network, the program when executed by a computer causing the computer to perform processing of:
collecting display screen data from the machine tool at a predetermined time interval, and accumulating the display screen data in a storage unit along with time information and individual identification information of the machine tool;
receiving a captured image of a display screen of a machine tool sent from an information terminal;
comparing between the captured image of the display screen of the machine tool received from the information terminal and the display screen data accumulated in the storage unit, and specifying the display screen data that is matching; and
sending individual identification information of a specified machine tool as a result of the comparing to the information terminal.

6. A non-transitory computer-readable medium encoded with a program for causing a computer to function as a server communicable with a plurality of machine tools via a network, the program when executed by a computer causing the computer to perform processing of:
receiving a captured image of a display screen of a machine tool sent from an information terminal;
instructing sending of display screen data to the machine tool when receiving the captured image from the information terminal, and collecting the display screen data along with time information and individual identification information of the machine tool;
comparing between the captured image of the display screen of the machine tool received from the information terminal and the display screen data collected in the processing of instructing, and specifying the display screen data that is matching; and
sending individual identification information of a specified machine tool as a result of the comparing to the information terminal.

7. A system comprising a server and a plurality of machine tools,
wherein the server comprises a control unit and a storage unit,
wherein the control unit includes:
an accumulating unit that collects display screen data from the machine tool at a predetermined time interval, and accumulates the display screen data in the storage unit along with time information and individual identification information of the machine tool;
a receiver that receives a captured image of a display screen of a machine tool sent from an information terminal;
a comparison unit that conducts a comparison between the captured image of the display screen of the machine tool received from the information terminal, and the display screen data accumulated in the storage unit, and specifies the display screen data that is matching; and
a transmitter that transmits individual identification information of a specified machine tool as a result of the comparison to the information terminal,
wherein the machine tool includes:
an acquisition unit that acquires display screen data of the machine tool; and
a transmitter that sends the display screen data acquired by the acquisition unit to the server.

8. A system comprising a server and a plurality of machine tools,
wherein the server comprises a control unit and a storage unit,
wherein the control unit includes:
a receiver that receives a captured image of a display screen of a machine tool sent from an information terminal;
an instruction unit that instructs sending of display screen data to the machine tool when receiving the captured image from the information terminal, and collects the display screen data along with time information and individual identification information of the machine tool;
a comparison unit that conducts a comparison between the captured image of the display screen of the machine tool received from the information terminal and the display screen data collected by the instruction unit, and specifies the display screen data that is matching; and
a transmitter that transmits individual identification information of a specified machine tool as a result of the comparison to the information terminal,
wherein the machine tool includes:
an acquisition unit that acquires display screen data of the machine tool;
a receiver that receives an instruction of sending of the display screen data from the server; and
a transmitter that sends the display screen data acquired by the acquisition unit to the server.
